(19) United States
(12) Patent Application Publication
(10) Pub. No.: US 2011/0187784 A1
(43) Pub. Date: Aug. 4, 2011

(54) LIQUID EJECTION DEVICE

(75) Inventor: Kazutoshi FUJISAWA, Okaya (JP)

(73) Assignee: SEIKO EPSON CORPORATION, Tokyo (JP)

(21) Appl. No.: 13/011,133

(22) Filed: Jan. 21, 2011

(30) Foreign Application Priority Data
Feb. 2, 2010 (JP) 2010-020955

(51) Int. Cl. B41J 29/393

(52) U.S. Cl. 347/19

(57) ABSTRACT

A liquid ejection device includes: a recording head for ejecting an ultraviolet curable ink onto continuous paper so that an image corresponding to liquid ejection data is formed on the continuous paper; an ultraviolet radiation device in which a plurality of ultraviolet LEDs for radiating ultraviolet rays onto the ink deposited on the continuous paper by ejection from the recording head are aligned along a direction that intersects the relative movement direction of the continuous paper; a camera for acquiring the image formed on the continuous paper as image data along the alignment direction of the ultraviolet LEDs, based on the ultraviolet radiation from the ultraviolet radiation device; and a control device for comparing the image data acquired by the camera with the liquid ejection data and distinguishing the quality of the ultraviolet LEDs based on the comparison results.

### CROSS-REFERENCE TO RELATED APPLICATIONS

This application claims priority to Japanese Patent Application No. 2010-020955 filed on Feb. 2, 2010. The entire disclosure of Japanese Patent Application No. 2010-020955 is hereby incorporated herein by reference.

### BACKGROUND

1. Technical Field

The present invention relates to an inkjet printer, for example, or another liquid ejection device.

2. Related Art

Inkjet printers (hereinbelow also referred to as “printers”) have been known in conventional practice as liquid ejection devices for ejecting ink (liquid) onto a target. Recently much attention has been given to ultraviolet curable ink as ink used in these printers. This ultraviolet curable ink cures extremely slowly until being irradiated with ultraviolet rays, then cures rapidly when irradiated with ultraviolet rays.

In a printer that uses such ultraviolet curable ink, an ultraviolet radiation device for radiating ultraviolet rays onto the ink deposited on the target by ejection from a recording head must be provided in a position downstream from the recording head (liquid ejection head) in the target conveying direction (see Japanese Laid-Open Patent Publication No. 2008-265285, for example).

In the printer of Japanese Laid-Open Patent Publication No. 2008-265285, the range of ultraviolet ray irradiation and the intensity of light (strength) can be appropriately varied by using numerous ultraviolet light-emitting elements as the light source of the ultraviolet radiation device and controlling these numerous ultraviolet light-emitting elements.

### SUMMARY

However, in an ultraviolet radiation device comprising a plurality of ultraviolet light-emitting elements as in Japanese Laid-Open Patent Publication No. 2008-265285, when a problem occurs in one ultraviolet light-emitting element, the intensity of ultraviolet light (intensity of radiation) changes and the ink in the corresponding portion is not cured. Therefore, there is a risk that the uncured ink will mix on the target, causing the image to blur and the image quality to be poor.

The present invention was devised in view of the problems described above, and an object thereof is to provide a liquid ejection device collectively performing a quality distinction on a plurality of ultraviolet light sources.

To achieve the object described above, the liquid ejection device according to a first aspect of the present invention includes a liquid ejection head, an ultraviolet radiation device, an image data acquisition device, a comparison unit and a distinction unit. The liquid ejection head is configured to eject an ultraviolet curable liquid onto a target so that an image corresponding to liquid ejection data is formed on the target. In the ultraviolet radiation device, a plurality of ultraviolet light sources configured to radiate ultraviolet rays onto the liquid deposited on the target by ejection from the liquid ejection head are aligned along a direction that intersects a relative movement direction of the target. The image data acquisition device is configured to acquire the image formed on the target as image data along an alignment direction of the ultraviolet light sources, based on ultraviolet radiation from the ultraviolet radiation device. The comparison unit is configured to compare the image data acquired by the image data acquisition device with the liquid ejection data. The distinction unit is configured to distinguish quality of the ultraviolet light sources based on a comparison result of the comparison unit.

According to this configuration, since the light intensity changes in an unsatisfactory ultraviolet light source and curing does not occur in the liquid of the corresponding image portion, a difference arises between the liquid ejection device and the image data. Therefore, by comparing the liquid ejection device and the image data, a quality determination can be performed collectively on a plurality of ultraviolet light sources. Therefore, unsatisfactory printing resulting from unsatisfactory ultraviolet light sources can be avoided.

In the liquid ejection device according to a second aspect, the image is preferably formed by liquids of at least two colors, and a ruled line is preferably drawn by a second colored liquid over an image recorded in a solid shape by a first colored liquid, the second colored liquid being different from the first colored liquid.

According to this configuration, since the liquid in the portion corresponding to the unsatisfactory ultraviolet light source is not cured, liquids of two colors mix together and the ruled line recorded on the solid image blurs. Therefore, a quality determination of the ultraviolet light source according to the image can be reliably performed.

In the liquid ejection device according to a third aspect, the image data acquisition device preferably acquires the image data by scanning along the alignment direction of the ultraviolet light sources.

According to this configuration, the image data acquisition device can acquire image data of the entire image by scanning along the alignment direction of the ultraviolet light sources, even when the image recorded on the target is larger in a direction orthogonal to the relative movement direction of the target than the range that the image data acquisition device can acquire at one time. Therefore, the quality of the ultraviolet light sources can be reliably determined.

In the liquid ejection device according to a fourth aspect, the image data acquisition device preferably includes a plurality of optical sensors configured to detect light from the image and convert the light to electric signals, the optical sensors being aligned along the alignment direction of the ultraviolet light sources so as to have an aligned length corresponding to an aligned length of the ultraviolet light sources.

According to this configuration, the image data acquisition device can acquire a high-quality image and provide it to the comparison unit, due to the plurality of optical sensors being disposed in alignment. Therefore, the quality of the corresponding light source can be determined more reliably.

The liquid ejection device according to a fifth aspect preferably further includes a plurality of the liquid ejection heads assigned for each liquid color, and a plurality of the ultraviolet radiation devices equal in number to the liquid ejection heads. The ultraviolet radiation devices are preferably disposed downstream in the relative movement direction of the target for each of the liquid ejection heads.

According to this configuration, a quality determination of the ultraviolet light sources in a plurality of ultraviolet radiation devices can be collectively performed, even when an ultraviolet radiation device is provided for each of a plurality of liquid ejection heads.

The liquid ejection device according to a sixth aspect preferably further includes a light intensity adjustment unit configured to adjust light intensity for each of the ultraviolet light sources. Among the plurality of ultraviolet light sources, the light intensity adjustment unit is preferably configured to increase the light intensity of the ultraviolet light sources disposed surrounding the ultraviolet light source distinguished to have unsatisfactory radiation based on a distinction result of the distinction unit.

According to this configuration, even if there is an unsatisfactory ultraviolet light source in the ultraviolet radiation device, the radiation intensity can be supplemented by the surrounding ultraviolet light sources. Therefore, high productivity can be maintained without a lapse in printing production even when there is an unsatisfactory ultraviolet light source.

### BRIEF DESCRIPTION OF THE DRAWINGS

Referring now to the attached drawings which form a part of this original disclosure:

FIG. 1 is a schematic front view of the printer in the first embodiment;

FIG. 2 is a schematic plan view of the printer in the first embodiment;

FIG. 3A is a partial schematic plan view of the ultraviolet radiation device, FIG. 3B is a partial enlarged view of the target recorded image according to the liquid ejection data in the first embodiment, and FIG. 3C is a partial enlarged view of the actual recorded image according to the image data in the first embodiment;

FIG. 4 is a schematic front view of the printer in the second embodiment;

FIG. 5 is a schematic plan view of the printer in the second embodiment;

FIG. 6 is a schematic front view of the printer in the third embodiment;

FIG. 7 is a schematic plan view of the printer in the third embodiment; and

FIG. 8 is an explanatory drawing showing an example of an actual recorded image according to image data in the third embodiment, and the positional relationship of the ultraviolet radiation devices to this image.

### DETAILED DESCRIPTION OF EXEMPLARY EMBODIMENTS

### First Embodiment

An embodiment in which the present invention is specified as an inkjet printer (hereinbelow also sometimes shortened to “printer”), which is one type of a liquid ejection device, is described hereinbelow according to FIGS. 1 through 3.

An inkjet printer 11 as a liquid ejection device is provided with an unreeling portion 13 for unreeling continuous paper 12 as a rectangular target, a printing portion 14 for performing a recording process by ejecting ink as a liquid onto the continuous paper 12, and a winding portion 15 for winding the continuous paper 12 on which the recording process has been performed, as shown in FIG. 1. The printing portion 14 is provided with a rectangular plate-shaped platen 16 capable of supporting the continuous paper 12.

That is, in the conveying direction of the continuous paper 12, the unreeling portion 13 is disposed in a position nearer to the left, which is the upstream side, and the winding portion 15 is disposed in a position nearer to the right, which is the downstream side. The printing portion 14 is disposed in a position between the unreeling portion 13 and the winding portion 15.

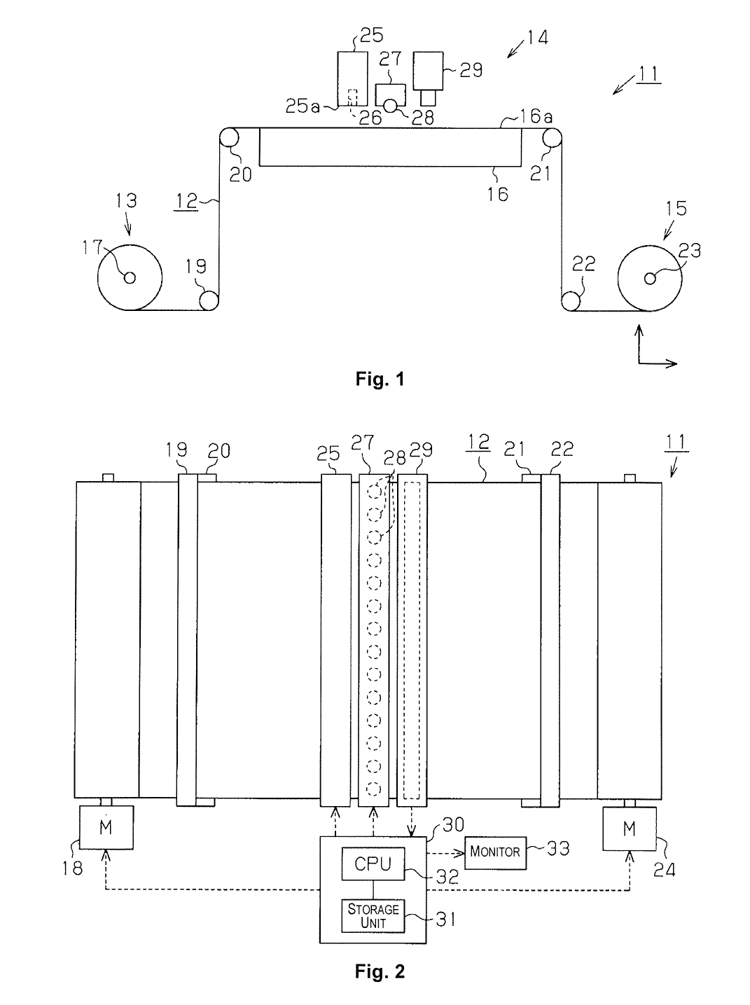

A winding shaft 17 extending in the forward-backward direction (the direction orthogonal to the image plane) is rotatably provided to the unreeling portion 13 as shown in FIG. 1. The continuous paper 12 is wound in advance in the form of a roll around the winding shaft 17 and is supported so as to be capable of rotating integrally with the winding shaft 17. That is, the winding shaft 17 rotates with the driving of a first conveying motor 18 (see FIG. 2), whereby the continuous paper 12 is unreeled from the unreeling portion 13 and conveyed downstream in the conveying direction.

A first roller 19, which converts the conveying direction of the continuous paper 12 to a vertical upward direction by winding the continuous paper 12 unreeled from the winding shaft 17 from the lower right, is provided to the right of the unreeling portion 13 so as to extend in the forward-backward direction, parallel to the winding shaft 17.

Furthermore, in a position to the left of the platen 16, corresponding with the lower first roller 19 in the up-down direction, a second roller 20 is provided so as to extend in the forward-backward direction, parallel with the lower first roller 19. The continuous paper 12, whose conveying direction has been converted to a vertical upward direction by the first roller 19, is then wound from the lower left onto the second roller 20, whereby the conveying direction is converted to a horizontal right direction and the continuous paper 12 slides over a support surface 16a, which is the top surface of the platen 16.

To the right of the platen 16, a third roller 21, which opposes the left second roller 20 on the opposite side of the platen 16 in the left-right direction, is provided so as to extend in the forward-backward direction, parallel with the second roller 20. The respective positions where the second roller 20 and the third roller 21 are disposed are adjusted so that the peaks of the respective peripheral surfaces of the rollers are of level height with the support surface 16a, which is the top surface of the platen 16. Therefore, the continuous paper 12, whose conveying direction has been converted to the horizontal right direction by the second roller 20, is then conveyed downstream to the right while sliding over the support surface 16a, which is the top surface of the platen 16, and the continuous paper 12 is then wound over the third roller 21 from the upper right, whereby the conveying direction is converted to a vertical downward direction.

Furthermore, in a position corresponding with the third roller 21 in the up-down direction, a fourth roller 22, which converts the conveying direction of the continuous paper 12 to the horizontal right direction by winding the continuous paper 12 being conveyed vertically downward from the lower left, is provided so as to extend in the forward-backward direction. The winding portion 15 is disposed to the right of the fourth roller 22, and the winding portion 15 is provided with a winding shaft 23 extending in the forward-backward direction, parallel with the fourth roller 22. The winding shaft 23 is designed so as to rotate based on the drive force of a second conveying motor 24 (see FIG. 2), and the distal end of the continuous paper 12, which is the downstream end in the conveying direction, is wound around the winding shaft 23.

In the printing portion 14 as shown in FIGS. 1 and 2, in the position farthest upstream in the conveying direction of the continuous paper 12, a recording head 25 as a line head type of liquid ejection head for ejecting ultraviolet curable ink which cures in response to ultraviolet rays is fixedly disposed so as to face the support surface 16a. The bottom surface of the recording head 25 is a horizontal nozzle formation surface 25a in which a plurality of nozzles 26 for ejecting ink are opened. The recording head 25 extends horizontally in a direction orthogonal to the conveying direction of the continuous paper 12, and the longitudinal length of the recording head 25 corresponds to the maximum paper width of the continuous paper 12. The nozzles 26 are aligned in the nozzle formation surface 25a along the direction in which the recording head 25 extends, and are designed to be capable of ejecting ink to form a target recording image based on liquid ejection data across the entire width of the printable (recordable) range of the continuous paper 12.

In the printing portion 14, downstream of the recording head 25 in the conveying direction of the continuous paper 12, an ultraviolet radiation device 27 capable of irradiating the continuous paper 12 with ultraviolet rays is fixedly disposed so as to face the support surface 16a. Similar to the recording head 25, the ultraviolet radiation device 27 extends in a direction orthogonal to the conveying direction of the continuous paper 12, and the longitudinal length of the ultraviolet radiation device 27 corresponds to the maximum paper width of the continuous paper 12. In the bottom surface of the ultraviolet radiation device 27, a plurality (e.g., fourteen in the present embodiment) of ultraviolet LEDs 28 as ultraviolet light-emitting elements are aligned in a single row along the direction in which the ultraviolet radiation device 27 extends, and are capable of radiating ultraviolet rays across the entire width of the image recorded on the continuous paper 12 in a single operation.

Furthermore, in the printing portion 14, downstream of the ultraviolet radiation device 27 in the conveying direction of the continuous paper 12, a camera 29, which is an image data acquisition device for capturing an image as an actual recorded image recorded on the continuous paper 12 after the ultraviolet radiation, is fixedly disposed so as to face the support surface 16a. Similar to the recording head 25 and the ultraviolet radiation device 27, the camera 29 extends in a direction orthogonal to the conveying direction of the continuous paper 12, and the longitudinal length of the camera 29 corresponds to the maximum paper width of the continuous paper 12. The camera 29 has a plurality of photoelectric conversion elements (hereinbelow indicated as “CCD elements”) as optical sensors (not shown) for detecting light from the image and converting the light into electric signals. The CCD elements are aligned in a single row along the direction in which the camera 29 extends, the CCD elements photograph the image after the ultraviolet radiation in a single operation, which is recorded across the entire width of the printable (recordable) range of the continuous paper 12, and the CCD elements send the acquired image data to a control device 30 (see FIG. 2).

The printer 11 also comprises a control device 30 electrically connected with the first conveying motor 18, the second conveying motor 24, the ultraviolet radiation device 27, and the camera 29, as shown in FIG. 2. The control device 30 comprises a storage unit 31 capable of reading and rewriting information, and a CPU 32 for executing various computations by functioning as a central processing device. Liquid ejection data outputted to the recording head 25, image data after ultraviolet radiation inputted from the camera 29, and other information is stored in the storage unit 31, and programs whereby the control device 30 performs various computation are stored in the storage unit 31 as well. The control device 30 controls the first conveying motor 18, the second conveying motor 24, the recording head 25, the ultraviolet LEDs 28 of the ultraviolet radiation device 27, and the camera 29. Furthermore, the control device 30 is connected to a monitor 33 for displaying information and the like stored in the storage unit 31.

The following is a description of the action of the printer 11 configured as described above. The description focuses particularly on the quality distinction of the ultraviolet LEDs 28 and the light intensity adjustment of the ultraviolet LEDs 28 based on the quality distinction.

Before printing is initiated in the printer 11 of the present embodiment, a quality determination is performed on the plurality of ultraviolet LEDs 28 in the ultraviolet radiation device 27 in order to determine whether or not printing is being performed properly.

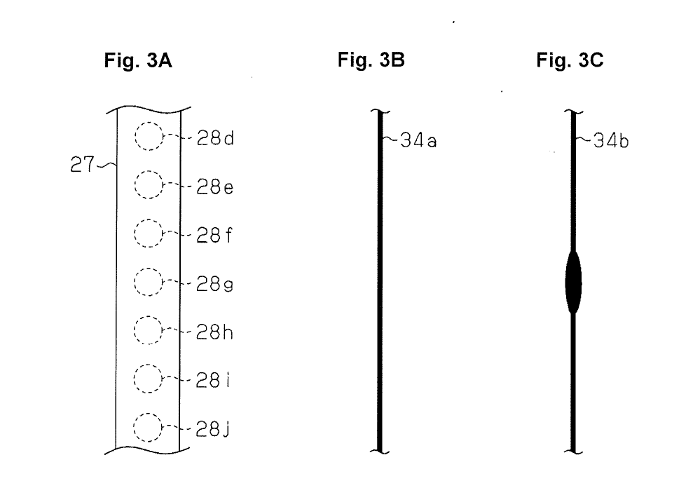

That is, in the printer 11, when the quality determination of the ultraviolet LEDs 28 is initiated, first, liquid ejection data for the quality determination of the ultraviolet LEDs 28 is inputted from the control device 30 to the recording head 25, the first conveying motor 18 and the second conveying motor 24 are driven, and the continuous paper 12 is conveyed from the upstream side to the downstream side of the conveying direction. At this time, the liquid ejection device causes a ruled line 34a to be recorded as a target recording image across the entire width of the recording area in the continuous paper 12, as shown in FIG. 3B. When the recording range of the continuous paper 12 passes below the recording head 25, ink is ejected from the recording head 25 based on the liquid ejection data, and an image (in this case, an image whose target recording image is the ruled line 34a) is recorded on the continuous paper 12.

Next, when the continuous paper 12 is conveyed in the conveying direction and passed below the ultraviolet radiation device 27, the image recorded on the continuous paper 12 is irradiated with ultraviolet rays from the ultraviolet radiation device 27, and the ink of the image is cured. In cases in which all of the ultraviolet LEDs 28 in the ultraviolet radiation device 27 are radiating ultraviolet rays satisfactorily, the liquid ejection data after the ultraviolet radiation is the same as the ruled line 34a, which is the target recording data based on the liquid ejection data.

In cases in which there are ultraviolet LEDs whose ultraviolet radiation is unsatisfactory (for example, the ultraviolet LED 28g from among the ultraviolet LEDs 28d through 28j shown in FIG. 3A) in the ultraviolet radiation device 27, the ink of the image in the portion corresponding to the unsatisfactory ultraviolet LED 28g blurs because it is not cured. Therefore, the image after ultraviolet radiation (i.e., the actual recorded image) is a different image (i.e., the ruled line 34b in which a blurred part is thicker) from the ruled line 34a which is the target recording image based on the liquid ejection data, as shown in FIG. 3C.

When the continuous paper 12 is further conveyed and passed below the camera 29, the image after the ultraviolet radiation (the actual recorded image) on the continuous paper 12 is photographed by the camera 29, and the acquired image data is sent to the storage unit 31 of the control device 30.

In the control device 30, which has acquired the image data from the camera 29, the liquid ejection data and the image data stored in the storage unit 31 are read in the CPU 32, and the read pieces of data are binarized in order to increase the image processing rate. The target recorded image of the binarized liquid ejection data and the actual recorded image of the image data are compared and the degree of coincidence of the image data corresponding to the liquid ejection data is calculated. That is, the thickness of the ruled line 34a in the liquid ejection data is compared with the thickness of the ruled line 34b in the image data, and the degree of coincidence in the thicknesses of the ruled lines is calculated.

In cases in which the degree of coincidence is a predetermined value or greater (e.g., 80% or greater) in the entire range of the image data, it is distinguished that all of the ultraviolet LEDs 28 in the ultraviolet radiation device 27 are satisfactory. The distinction results are transmitted to the monitor 33, and the distinction results are displayed on the monitor 33.

In cases in which there is an area in the image data where the degree of coincidence is a predetermined value or less (e.g., 80% or less), the ultraviolet LED 28 corresponding to the area where the degree of coincidence is the predetermined value or less is pinpointed in the ultraviolet radiation device 27, and this ultraviolet LED 28 is distinguished as having unsatisfactory radiation. The distinction results are then sent to the monitor 33, and the monitor 33 displays the distinction results and the position in the ultraviolet radiation device 27 of the ultraviolet LED 28 distinguished as having unsatisfactory radiation. In this respect, the control device 30 functions as a comparison unit and a distinction unit.

In cases in which the quality distinction of the ultraviolet LEDs 28 shows that there is an ultraviolet LED 28 having unsatisfactory radiation, the ultraviolet light intensity of the ultraviolet LEDs 28 is adjusted by the control device 30. That is, the ultraviolet light intensity in the area corresponding to the ultraviolet LED 28 having unsatisfactory radiation is supplemented by selectively increasing the intensity of light emitted by the ultraviolet LEDs 28 disposed around the periphery (e.g., on both sides in the present embodiment) of the ultraviolet LED 28 distinguished as having unsatisfactory radiation. The appropriate ultraviolet radiation range and ultraviolet radiation intensity of the ultraviolet radiation device 27 are maintained. In this respect, the control device 30 functions as a light intensity adjustment unit.

According to the embodiment described above, the following effects can be achieved.

(1) By comparing the liquid ejection data and the image data after ultraviolet radiation acquired by the camera 29 and calculating the degree of coincidence of the two pieces of data, a quality distinction of the plurality of ultraviolet LEDs 28 can be collectively performed. Therefore, unsatisfactory printing resulting from unsatisfactory radiation can be avoided.

(2) Since an image after ultraviolet radiation is photographed by a camera 29 having CCD elements, high-quality image data can be acquired and provided to the control device 30. Therefore, the quality of the corresponding ultraviolet LEDs 28 can be accurately determined.

(3) The intensity of ultraviolet light is increased in the ultraviolet LEDs 28 disposed around the periphery of the ultraviolet LED 28 distinguished as having unsatisfactory radiation, and the ultraviolet light intensity is supplemented in the range of unsatisfactory ultraviolet radiation. Therefore, even if there is an ultraviolet LED 28 having unsatisfactory radiation, high productivity can be maintained without a lapse in printing production.

### Second Embodiment

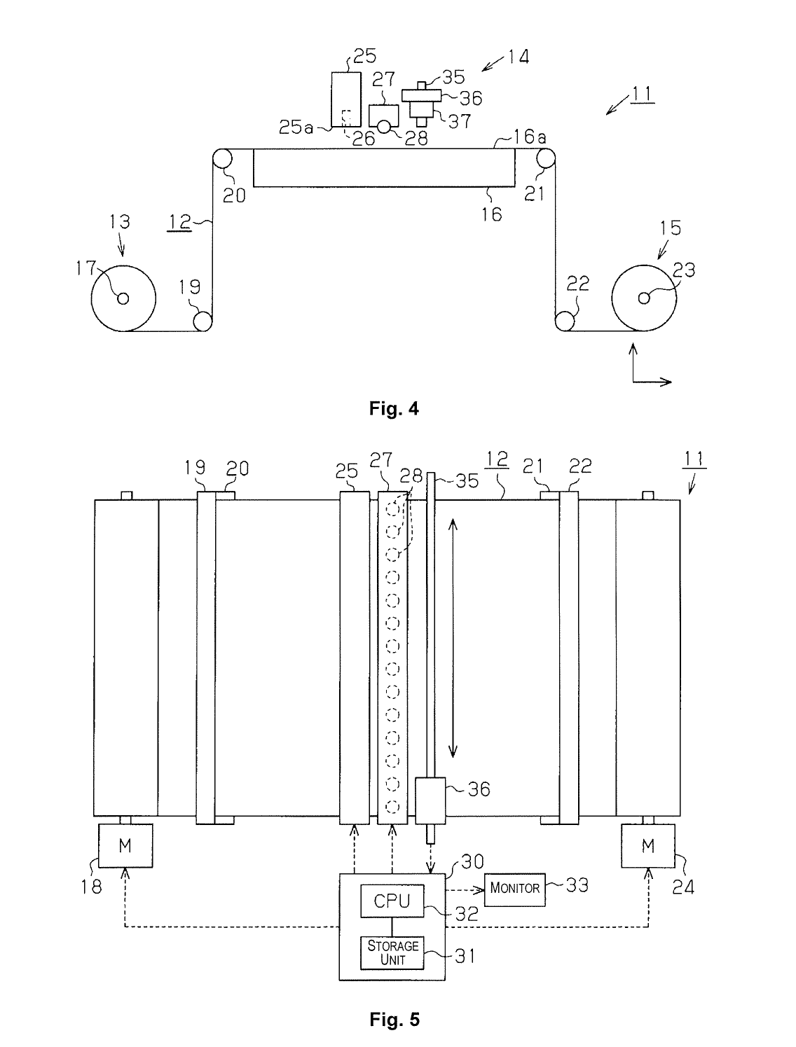

Next, the second embodiment of the present invention is described based on FIGS. 4 and 5. To compare the second embodiment to the first embodiment, the configuration of the printing portion 14 is different in one respect, but the configuration is otherwise substantially identical to that of the first embodiment. Therefore, the description hereinbelow is primarily of the points that differ from the first embodiment, similar components are denoted by the same symbols, and redundant descriptions are omitted.

In the printing portion 14 of the present embodiment as shown in FIGS. 4 and 5, downstream of the ultraviolet radiation device 27 in the conveying direction of the continuous paper 12, a guide rail 35 whose longitudinal length corresponds to the maximum paper width of the continuous paper 12 is fixedly disposed extending in a direction orthogonal to the conveying direction of the continuous paper 12, similar to the recording head 25 and the ultraviolet radiation device 27. On the underside of the guide rail 35 (the side facing the support surface 16a), a rectangular carriage 36, whose longitudinal length is shorter than the maximum paper width of the continuous paper 12, is supported so as to be capable of moving back and forth based on the driving of a drive mechanism (not shown) in a direction orthogonal to the conveying direction of the continuous paper 12 along the guide rail 35. On the underside of this carriage 36, a camera 37, which is an image data acquisition device whose longitudinal length is substantially the same as that of the carriage 36, is supported so as to face the support surface 16a. A plurality of CCD elements (not shown) are aligned in a signal row in the longitudinal direction on the camera 37. The camera 37 acquires the image data after ultraviolet radiation recorded across the entire width of the printable (recordable) range of the continuous paper 12, by the carriage 36 moving back and forth along the guide rail 35.

According to the embodiment described above, the following effects can be achieved.

(4) The camera 37 can acquire image data of the entire image even when the image after ultraviolet radiation recorded on the continuous paper 12 is larger in a direction orthogonal to the conveying direction of the continuous paper 12 than the range that the camera 37 can acquire at one time.

### Third Embodiment

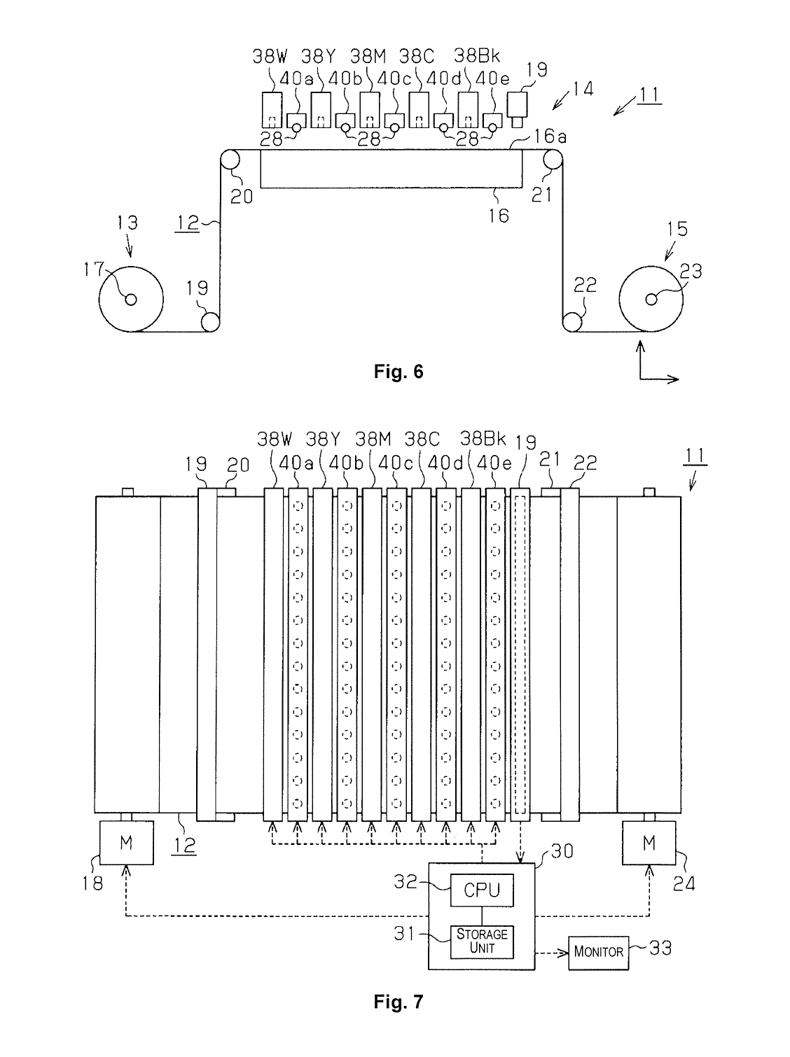

Next, the third embodiment of the present invention is described based on FIGS. 6 and 7. To compare the third embodiment to the first embodiment and second embodiment, the configuration of the printing portion 14 and the configuration of the image recorded on the continuous paper 12 during quality distinction of the ultraviolet LEDs 28 are different in one aspect, but the configuration is otherwise substantially identical to those of the first embodiment and the second embodiment. Therefore, the description hereinbelow is primarily of the points that differ from the first embodiment and second embodiment, similar components are denoted by the same symbols, and redundant descriptions are omitted.

In the printing portion 14 of the present embodiment as shown in FIGS. 6 and 7, five recording heads 38W, 38Y, 38M, 38C, 38Bk corresponding to ultraviolet curable inks of the colors white (W), yellow (Y), magenta (M), cyan (C), and black (Bk) are fixedly disposed in the stated order from the upstream side to the downstream side in the conveying direction of the continuous paper 12, so as to face the support surface 16a. The recording heads 38W, 38Y, 38M, 38C, 38Bk, which are line head type recording heads, extend horizontally in a direction orthogonal to the conveying direction of the continuous paper 12, and the longitudinal length of the recording heads corresponds to the maximum paper width of the continuous paper 12. On the undersides of the recording heads 38W, 38Y, 38M, 38C, 38Bk, nozzles 39a through 39e for ejecting the respective inks are aligned along the direction in which the recording heads 38W, 38Y, 38M, 38C, 38Bk extend, and the nozzles are designed so as to be capable of ejecting ink across the entire width of the printable (recordable) range of the continuous paper 12.

In the printing portion 14, respective ultraviolet radiation devices 40a through 40e are fixedly disposed downstream of the recording heads 38W, 38Y, 38M, 38C, 38Bk in the conveying direction of the continuous paper 12, so as to face the support surface 16a. Similar to the recording heads 38W, 38Y, 38M, 38C, 38Bk, the ultraviolet radiation devices 40a through 40e extend in a direction orthogonal to the conveying direction of the continuous paper 12, and the longitudinal length of the ultraviolet radiation devices corresponds to the maximum paper width of the continuous paper 12. On each of the undersides of the ultraviolet radiation devices 40a through 40e, a plurality (e.g., fourteen in the present embodiment) of ultraviolet LEDs 28 are aligned in a single row along the direction in which the ultraviolet radiation devices 40a through 40e extend, and ultraviolet rays can be radiated at one time across the entire width of the image recorded on the continuous paper 12.

Furthermore, in the printing portion 14, a camera 29 is fixedly disposed so as to face the support surface 16a in the position farthest downstream in the conveying direction of the continuous paper 12.

The following is a description of the action of the printer 11 configured as described above. The description focuses particularly on the quality distinction of the ultraviolet LEDs 28 and the light intensity adjustment of the ultraviolet LEDs 28 based on the quality distinction.

When the quality determination of the ultraviolet LEDs 28 is initiated in the printer 11, first, liquid ejection data for the quality determination of the ultraviolet LEDs 28 is inputted from the control device 30 to the recording head 38, the first conveying motor 18 and the second conveying motor 24 are driven, and the continuous paper 12 is conveyed from the upstream side to the downstream side of the conveying direction. The target recording image according to the liquid ejection data at this time is composed of a rectangular solid image recorded by inks of different colors across the entire width of the recording range in the continuous paper 12, on top of which a ruled line is drawn by the recording head 38 disposed one position downstream from the recording head 38 of the color in which the solid image was recorded. First, when the recording range of the continuous paper 12 passes below the recording head 38W as shown in FIG. 6, a white rectangular solid image 41W spanning the entire width of the recording range of the continuous paper 12 is recorded on the continuous paper 12 by the recording head 38W, based on the liquid ejection data.

Next, when the continuous paper 12 is conveyed along the conveying direction and passed underneath the ultraviolet radiation device 40a, ultraviolet rays are radiated from the ultraviolet radiation device 40a onto the white rectangular solid image 41W recorded on the continuous paper 12, and the ink of the image irradiated by these ultraviolet rays is cured.

Next, when the continuous paper 12 is conveyed along the conveying direction and passed underneath the recording head 38Y, a yellow ruled line 42Y is drawn on the white rectangular solid image 41W by the recording head 38Y, and a yellow rectangular solid image 41Y similar to the white rectangular solid image 41W is then recorded adjacent to the white rectangular solid image 41W.

Furthermore, when the continuous paper 12 is conveyed along the conveying direction and passed underneath the ultraviolet radiation device 40b, ultraviolet rays are radiated from the ultraviolet radiation device 40b onto the yellow ruled line 42Y and the yellow rectangular solid image 41Y recorded on the continuous paper 12, and the ink irradiated by these ultraviolet rays is cured.

As the continuous paper 12 is thereafter conveyed downstream in the conveying direction, different-colored ruled lines 42M, 42C, 42Bk and rectangular solid images 41M, 41C, 41Bk are recorded respectively by the recording heads 38M, 38C, 38Bk on the continuous paper 12, similar to the case of the recording head 38Y. In these respects, the colored inks for recording the rectangular solid images (41M and the others) function as first colored liquids, and the colored inks for recording the ruled lines (42M and the others) on the solid images (41M and the others) function as second colored liquids. Ultraviolet rays are then radiated by the ultraviolet radiation devices 40c through 40e onto the respective ruled lines 42M, 42C, 42Bk and the solid images 41M, 41C, 41Bk, similar to the cases of the ultraviolet radiation devices 40a, 40b.

When the continuous paper 12 passes underneath the camera 29, the image after ultraviolet radiation on the continuous paper 12 is photographed as an actual recorded image by the camera 29, and the acquired image data is sent to the control device 30.

In the control device 30 which has acquired the image data of the actual recorded image from the camera 29, the target recording image of the liquid ejection data and the actual recorded image of the image data are compared, and the degree of coincidence of the image data relative to the liquid ejection data is calculated. A quality determination of the ultraviolet LEDs 28 in the ultraviolet radiation devices 40a through 40e is then performed according to the degree of coincidence of the image data.

When there is an ultraviolet LED 28 having unsatisfactory radiation in the ultraviolet radiation devices 40a through 40e, the ink in the portion corresponding to the ultraviolet LED 28 of unsatisfactory radiation is not cured, and the ink forming the solid image (41M or another) and the ink of the ruled line (42M or another) mix together and blur. Part of the color border 43 between two adjacent solid images (41M and 41Y or others) also blurs.

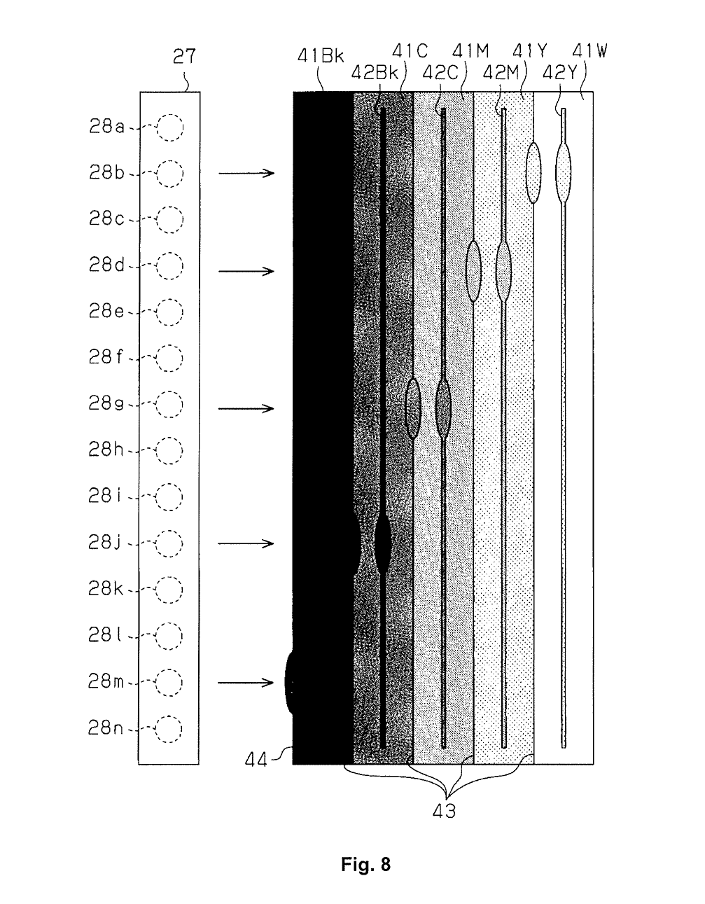

Therefore, the degree of coincidence relative to the liquid ejection data of the image data decreases in the portion corresponding to the ultraviolet LED having unsatisfactory radiation from among all of the ultraviolet LEDs 28s through 28n constituting a row. Therefore, in the ultraviolet radiation device 40a as shown in FIG. 8, the ultraviolet LED 28b disposed in a position corresponding to the blurred portion of the ruled line 42Y is distinguished as having unsatisfactory radiation. Similarly, the ultraviolet LED 28d in the ultraviolet radiation device 40b, the ultraviolet LED 28g in the ultraviolet radiation device 40c, and the ultraviolet LED 28j in the ultraviolet radiation device 40d are distinguished as having unsatisfactory radiation.

When there is an ultraviolet LED 28 having unsatisfactory radiation in the ultraviolet radiation device 40e, blurring occurs in part of the lengthwise edge 44 of the black rectangular solid image 41Bk, this edge extending in the longitudinal direction and being not adjacent to the cyan rectangular solid image 41C, and the degree of coincidence of the image data of the corresponding portion decreases. Therefore, in the ultraviolet radiation device 40e, the ultraviolet LED 28m, which is disposed in a position corresponding to the portion where the lengthwise edge 44 blurs in the black rectangular solid image 41Bk, is determined to have unsatisfactory radiation.

According to the embodiment described above, the following effects can be achieved.

(5) Since inks of two different colors mix and the blurred portion is easy to determine in the image portion corresponding to the ultraviolet LED 28 having unsatisfactory radiation, quality determination of the ultraviolet LEDs 28 can be reliably performed according to the image.

The embodiments described above may be modified as follows.

In the embodiments described above, a light source other than an ultraviolet LED (e.g., a metal hydro lamp, a xenon lamp, a carbon arc light, a chemical lamp, a low-pressure mercury lamp, a high-pressure mercury lamp, or the like) may be used as the ultraviolet light source.

In the embodiments described above, a plurality of rectangular recording heads, ultraviolet radiation devices, or cameras may be aligned along the width of the continuous paper 12.

In the embodiments described above, a rectangular recording head may be designed to perform recording over the entire width of the continuous paper 12 by moving in a direction that intersects the conveying direction of the continuous paper 12.

In the embodiments described above, the target is not limited to an elongated shape, and may be a shorter rectangular target (e.g., recording paper or the like). The target may also be a film or a fibrous medium.

In the embodiments described above, the ink colors, the combinations of colors, and the array of colors may be modified.

In the embodiments described above, the control device 30 may adjust the light intensity of the ultraviolet LEDs 28.

In the embodiments described above, the camera does not need to have CCD elements disposed in a single row. Optical sensors other than CCD elements (e.g., complementary metal-oxide semiconductors (CMOS) or the like) may also be used.

In the embodiments described above, the images used in the quality determination of the ultraviolet LEDs 28 are not limited to ruled lines alone and ruled lines recorded on solid rectangular shapes, and other images may be used.

In the embodiments described above, a liquid ejection device was specified as the inkjet printer 11, but a liquid ejection device that ejects or discharges a liquid other than ink may also be used. The present invention is applicable to various liquid ejection devices comprising liquid ejection heads or the like for discharging droplets in extremely small amounts. The term “droplets” refers to the state of the liquid discharged from the liquid ejection device, and includes that which leaves trails of grains, tears, or threads. The liquid referred to herein need only be a substance that can be ejected by the liquid ejection device. For example, the material need only be in the state of a liquid which includes not only fluids such as liquids of high and low viscosity, sols, gels, other inorganic solvents, organic solvents, solutions, liquid resins, and liquid metals (metal melts); and liquids as one state of the substance; but also includes liquids containing functional materials composed of pigments, metal particles, or the like which are dissolved, dispersed, or mixed in a solvent. Typical examples of the liquids include ink such as the ink described in the embodiments described above, liquid crystal, and the like. The term “ink” used herein includes common water-based ink and oil-based ink, as well as gel ink, hot melt ink, and other various liquid compositions. Specific examples of the liquid ejection device include liquid ejection devices which eject a liquid containing an electrode material, a coloring material, or the like in the form of a dispersion or a solvent, which is used in the manufacture of liquid crystal displays, EL (electroluminescence) displays, surface-emitting displays, color filters, and the like, for example; liquid ejection devices which eject a biological organic substance used to manufacture biochips; liquid ejection devices which are used as precision pipettes and which eject a liquid as a test sample; printing devices, micro dispensers; and the like. Further options which may be used include liquid ejection devices which eject lubricating oil at pinpoints onto watches, cameras, and other precision instruments; liquid ejection devices for ejecting an ultraviolet curing resin or another transparent resin liquid onto a substrate in order to form a microscopic semispherical lens (optical lens) or the like used in an optical communication element or the like; and liquid ejection devices for ejecting an acid, an alkali, or another etching liquid in order to etch a substrate or the like. The present invention can be applied to any one of these types of liquid ejection devices.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least +5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A liquid ejection device comprising:
a liquid ejection head configured to eject an ultraviolet curable liquid onto a target so that an image corresponding to liquid ejection data is formed on the target;
an ultraviolet radiation device in which a plurality of ultraviolet light sources configured to radiate ultraviolet rays onto the liquid deposited on the target by ejection from the liquid ejection head are aligned along a direction that intersects a relative movement direction of the target;
an image data acquisition device configured to acquire the image formed on the target as image data along an alignment direction of the ultraviolet light sources, based on ultraviolet radiation from the ultraviolet radiation device;
a comparison unit configured to compare the image data acquired by the image data acquisition device with the liquid ejection data; and
a distinction unit configured to distinguish quality of the ultraviolet light sources based on a comparison result of the comparison unit.

2. The liquid ejection device according to claim 1, wherein
the image is formed by liquids of at least two colors, and a ruled line is drawn by a second colored liquid over an image recorded in a solid shape by a first colored liquid, the second colored liquid being different from the first colored liquid.

3. The liquid ejection device according to claim 1, wherein
the image data acquisition device acquires the image data by scanning along the alignment direction of the ultraviolet light sources.

4. The liquid ejection device according to claim 1, wherein
the image data acquisition device includes a plurality of optical sensors configured to detect light from the image and convert the light to electric signals, the optical sensors being aligned along the alignment direction of the ultraviolet light sources so as to have an aligned length corresponding to an aligned length of the ultraviolet light sources.

5. The liquid ejection device according to claim 1, further comprising
a plurality of the liquid ejection heads assigned for each liquid color, and
a plurality of the ultraviolet radiation devices equal in number to the liquid ejection heads,
the ultraviolet radiation devices being disposed downstream in the relative movement direction of the target for each of the liquid ejection heads.

6. The liquid ejection device according to claim 1, further comprising
a light intensity adjustment unit configured to adjust light intensity for each of the ultraviolet light sources,
among the plurality of ultraviolet light sources, the light intensity adjustment unit being configured to increase the light intensity of the ultraviolet light sources disposed surrounding the ultraviolet light source distinguished to have unsatisfactory radiation based on a distinction result of the distinction unit.
